(19) United States
(12) Patent Application Publication
(10) Pub. No.: US 2015/0272168 A1
(43) Pub. Date: Oct. 1, 2015

(54) FOAMING ANIMAL ATTRACTANT AND METHOD OF USE

(71) Applicant: PURINA ANIMAL NUTRITION LLC, Shoreview, MN (US)

(72) Inventors: Kent J. Lanter, Waterloo, IL (US); Larry Varner, New Braunfels, TX (US)

(73) Assignee: PURINA ANIMAL NUTRITION LLC, Shoreview, MN (US)

(21) Appl. No.: 14/227,584

(22) Filed: Mar. 27, 2014

(51) Int. Cl. A23K 1/18; A23K 1/16; A23K 1/175

(52) U.S. Cl. CPC A23K 1/1813; A23K 1/1751; A23K 1/1646

(57) ABSTRACT

A feed product for animals foams and expands when blended with an activator. The feed product is a liquid or a paste. The foaming can be carried out using a variety of foaming agents. A disclosed foaming feed composition includes water, one or more food components, and a reactive combination that reacts to form a gas, wherein the reactive combination including a first reactive component and a second reactive component. Methods of forming and using the foaming feed compositions are also described.

### TECHNICAL FIELD

The present disclosure relates to feeding or attracting animals in the wild, in a large enclosure, or in a semi-enclosed area. The present disclosure also relates to providing animals in small enclosures a means of enrichment or entertainment.

### BACKGROUND

People rely on various methods to modify the behavior of an animal or group of animals. In attracting deer, elk, wild boar or feral pigs, game birds, bear, wolves, goats, sheep, moose, or other wild animals to a particular spot in an open area, large enclosed area, or semi-enclosed area, for example, people often seek to establish a pattern of behavior where the animal is conditioned to return to the selected spot by providing an attractive scent or airborne compound, a desirable item, or both for one or more animals in a selected location on a repeated basis. The one or more animals become conditioned to return to the spot to obtain the item, or because of the attractive scent or airborne compound. Common attractive items people employ for conditioning purposes include, for example, salt licks for deer, nesting materials for birds, pheromone, urine, or estrous odors provided by sprays and the like, and food.

Food attractants are among the most commonly employed items for attracting wild animals to a selected location. For many species, food attractants are the most successful known means to attract a selected animal. In the case of certain animals, such as deer, food is a highly successful attractant, particularly in the winter months when food sources for the deer become less plentiful, or in areas of high population density.

It is desirable to provide a food attractant that will condition a type of selected animal over a large area that is enclosed, semi-enclosed, or unenclosed, wherein an increased area over which an animal can detect the food attractant is provided. It is desirable to provide a food attractant that can be placed in an initial location that is difficult or impossible for the animal to reach, wherein the attractant is caused to move out of the initial location over time causing the food attractant to last longer since the animal or animals cannot eat it quickly but must wait for additional food attractant to appear.

Another form of animal behavior modification is environmental enrichment. Environmental enrichment is the process of providing stimulating environments for animals kept in small enclosures, such as cages, zoo enclosures, and the like, in order to enhance their well-being and prevent abnormal or even pathological behaviors in highly intelligent species. Enrichment includes the introduction of objects, smells, and other stimuli in the animal's environment. While food items are one such stimuli, it is difficult to provide food stimuli that will not be depleted too quickly and/or provide the animal with too high a caloric intake if ingested too frequently or in too high an amount on a daily basis. One solution is “puzzle feeders” wherein food is a reward for solving a problem. Such feeders provide entertainment and satisfy the natural need to forage.

Additional materials for providing such stimuli are desirable for animal enrichment purposes. It is desirable to provide a food enrichment product that can be placed in an initial location that is difficult or impossible for the animal to reach, wherein the attractant is caused to move out of the initial location over time so that the animal can reach it.

### SUMMARY

Disclosed herein is a feed product for animals that foams and expands when an activator is blended with it. The feed product is a liquid or a paste. The foaming is carried out using a variety of foaming agents.

In one type of embodiment, a foaming feed composition includes water, one or more food components, and a reactive combination that reacts to form a gas, the reactive combination including a first reactive component and a second reactive component.

In another type of embodiment, a kit includes a foaming feed premix and an activator, the foaming feed premix including one or more food components, wherein the activator is adapted for addition to the foaming feed premix to form a foaming feed composition.

In yet another type of embodiment, a method of forming a foaming feed composition includes combining water, one or more food components, and a first reactive component in a container to form a foaming feed premix; providing a second reactive component in a separate container; and mixing the second reactive component with the foaming feed premix to form a foaming feed composition.

### DETAILED DESCRIPTION

### Overview

Various embodiments will be described in detail. Reference to various embodiments does not limit the scope of the claims attached hereto. Additionally, any examples provided herein are not intended to be limiting and merely set forth some of the many possible embodiments for the appended claims.

As used herein, the term “deer” or “Cervidae” generally means a ruminant mammal of the family Cervidae, including white-tail deer, mule deer, black-tail deer, elk, moose, red deer, caribou, fallow deer, roe deer, pudú, and chital.

As used herein, the term “about” modifying, for example, the quantity of an ingredient in a composition, concentration, volume, process temperature, process time, yield, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

The foaming feed compositions of the invention have several advantages for attracting wild animals in an open, semi-enclosed, or large enclosed areas and for establishing a pattern of behavior wherein one or more animals are conditioned to return to the selected spot. The foaming feed compositions are easy to make and transport, and easy for an end user to apply. The foaming feed compositions are easily applied to a variety of surfaces, including uneven surfaces having crevices, cracks, convolutions, folds, and the like and thus are difficult for an animal to deplete fully. In some embodiments, the foaming feed compositions are advantageously applied to areas the selected animals find difficult or impossible to reach, wherein the foaming action of the feed compositions moves the foam out of the initial location to where the animal can reach it due to the increased volume of the compositions provided by foam formation. Thus, the foaming feed compositions can be placed, for example, inside a hollow tree trunk or in a man-made container having a small opening wherein the selected animal cannot reach inside or fit their mouth or tongue inside. The foaming action of the foaming feed compositions causes the composition to discharge from the enclosed or unreachable area. Slower-foaming compositions are advantageously employed to effectively meter out the foaming feed compositions, thereby providing a source of interest for enrichment or providing a prolonged lifetime of the feed attractant to wild or semi-tame animals in an enclosed, semi-enclosed, or open area.

The foaming feed compositions provide for the increased amount of aromas or other volatile compounds released from the feed composition by forming gas bubbles that entrain volatile compounds, wherein the burst bubbles then release the molecules into the environment. Food odors or other odors or volatile attractants such as pheromones are advantageously dispersed using the foaming feed compositions. In embodiments, effective amounts of one or more attractive odors are dispersed over a larger area due to increased amounts of the odors being released in a selected period of time when compared to feed compositions that do not foam.

In various embodiments, the foaming feed compositions include at least a foaming agent, water, and a food component suitable for feeding a selected animal. The foaming agents and food components and other aspects of the composition are described below in detail. In some embodiments, the foam feed compositions are directed towards deer as the selected animal.

In some embodiments, the foaming feed compositions have a syrup-like or even a paste-like viscosity that is provided by blending the one or more food components with one or more viscosifiers and water. In such embodiments, the foaming feed composition is a thickened foaming feed or thickened foaming feed composition. It will be appreciated that the thickened foaming feed compositions are a subset of the foaming feed compositions as determined by context below. The increased viscosity of the thickened foaming feed compositions, in embodiments, slows the eruption of bubbles that form in the thickened foaming feed. Slower eruption of bubbles is advantageous, in some embodiments, to provide a longer-term release of aromas from the foaming feed composition, or to increase the extent of discharge of the foaming feed composition from a difficult or hard to reach location by increasing the number of bubbles that remain intact within the composition, thereby increasing foam volume. The rate of bubble eruption may be adjusted by adjusting the viscosity of the thickened foaming feed compositions and particle size of the foaming agents.

Composition

The foaming feed compositions described herein include at least a food component, water, and a foaming additive. The thickened foaming feed compositions include one or more viscosifiers. Optionally, the foaming feed compositions include citric acid as a palatant or palatability enhancing agent; in some compositions, citric acid is one component of a two-part foaming agent. Food components are employed in a wide variety of combinations with water, a foaming additive, and optionally citric acid and/or one or more viscosifiers. The food components suitable for including in the foaming feed compositions are not particularly limited by their recitation herein; it will be appreciated by those having skill that food components are selected for attracting the selected species of animal for behavior modification. As such, any combination of food components known to the palatable or attractive to the animal is suitably employed in the foaming feed compositions of the invention.

The type of foaming agent employed in the foaming feed compositions is not particularly limited. Suitable foaming agents include propellants, propellants in combination with nucleating agents wherein the nucleating agent is added by the end user to accelerate foam formation, and components employed by end users to initiate two-part foam-forming reactions. In some embodiments the foaming agent is a propellant, wherein the foaming feed composition is provided in a pressurized package and, upon the user dispensing the composition onto or into a substrate, the propellant expands and the foam is formed by the expansion. Such packaging and dispensing technologies are well known in the industry and any of the known packaging or dispensing mechanisms employed to provide pressurized propellant-containing liquid compositions is suitably employed in conjunction with the foaming feed compositions containing propellant. Suitably employed propellants include, for example, propane, isobutane, n-butane, hydrofluorocarbons 134A (1,1,1,2,-tetrafluoroethane), 227 (1,1,1,2,3,3,3-heptafluoropropane), or 152A (CAS No. 75-37-6), carbon dioxide, nitrous oxide, or a mixture of two or more thereof. In some embodiments, the propellant does not interfere with the animal's sense of smell or the organoleptic properties associated with the attractant aromas, pheromone elements, or food components of the foaming feed compositions. In some embodiments, the propellant is carbon dioxide or nitrous oxide.

In some embodiments, the foam is formed by a two-part foam-forming reaction. In such embodiments the user combines the contents of a two-part package to start the reaction and initiate foaming. In some such embodiments the combining is done at the same time as the dispensing of the foaming feed composition. In some such embodiments suitable packaging systems for contemporaneous mixing and dispensing of a two-part system are advantageously employed. In some embodiments the two-part package includes a first part including at least water, one or more food components, and a first compound that can participate in a gas-forming reaction; a second part includes at least a second compound that can participate in a gas forming reaction with the first compound. In some such embodiments, the second part further includes water, one or more food components, or both.

In various embodiments described below, a two-part mixture that when combined forms a foaming feed mixture is not a foaming feed mixture prior to the mixing of the two parts. In such embodiments, one or more parts thereof may be referred to as a “foaming feed premix”, wherein the premixes typically contain at least water and one or more food components.

In some embodiments, the foam forming chemical reaction is accomplished by a reactive combination that undergoes a reaction that forms a gas, and the gas forms the foam in the foaming feed composition. The reactive combination includes a first reactive component and second reactive component, wherein the reactive combination is formed by an action taken by an end user. The first reactive component, second reactive component, or both include a single compound or a mixture of two or more compounds. In some such embodiments, two or more compounds present in a reactive component are employed to provide two different chemical reactions, a first reaction foam forming reaction and a second foam forming reaction that is slower than the first foam forming reaction, such that the initial formation of foam by the first foam forming reaction is followed by the additional, slower rate of foam formation caused by the second foam forming reaction. This dual reaction method extends the overall lifetime of the foam by replacing some portion of the foam bubbles as they erupt.

In some embodiments, the first reactive component is present in a foaming feed premix, and the user adds the second reactive component to the premix to form the foaming feed composition. In such embodiments, the second reactive component can be included as an “activator” in a kit, the kit containing the foaming feed premix and the activator, the activator designed and adapted to add to the premix using one of the packaging embodiments and one of the methods of addition and mixing described herein.

In other embodiments, both reactive components are added by the end user to the foaming feed premix in order to form the foaming feed composition. In some such embodiments, the two reactive components are supplied in two activator packages, as part of a kit that includes the foaming feed premix, wherein the reactive components are mixed prior to or contemporaneously with the addition of the mixture to the foaming feed premix; in other such embodiments the two reactive components are provided in a single activator package as a mixture, wherein the mixture is triggered to react by dissolution in the water provided in the foaming feed premix. For example, in some embodiments an activator is two powdered compounds that undergo an acid-base reaction, wherein the two compounds are safely commingled in a dry mixture, further wherein upon dissolution in water the acid-base reaction is initiated. In another such embodiment, a compound that reacts with water to form a first reactive compound may be safely packaged with the second reactive compound in a dry mixture, and provided as an activator in a kit that also includes the foaming feed premix. One example of this embodiment is described below, wherein the first reactive compound is an anhydride that breaks down into an acid on contact with water, and the second reactive compound is sodium carbonate or sodium bicarbonate. In yet other embodiments, a foaming feed premix is a combination of one or more food components, the first reactive component, and the second reactive component, and water is the activator as supplied in a kit.

Suitable examples of reactive combinations include salts of carbonic acid as one reactive component and a Bronsted-Lowry (protic) acid as the other reactive component, wherein the reaction thereof yields carbon dioxide gas and the salt of the acid. The strength of the acid required to provide the reaction is determined by the particular salt species employed in such reactions. Thus, for example, sodium carbonate or sodium bicarbonate undergo reactions with weak protic acids to yield carbon dioxide and the sodium salt of the acid. Weak protic acids include organic acids such as acetic acid, propionic acid, butyric acid, lactic acid, tannic acid, malic acid, gluconic acid, glycolic acid, pyruvic acid, glutamic acid, fumaric acid, succinic acid, citric acid, isocitric acid, pimelic acid, linear polycarboxylic acids such as oxalic acid, malonic acid, succinic acid, glutaric acid, and adipic acid; and anhydrides that break down into acids on contact with water, such as acetic anhydride, butyric anhydride, malonic anhydride, or succinic anhydride; and combinations of two or more thereof.

In embodiments, calcium carbonate requires a stronger acid than sodium carbonate in order to yield carbon dioxide. In embodiments, useful acids employed in a reaction with calcium carbonate to liberate a significant amount of carbon dioxide include hydrochloric acid, sulfuric acid, or nitric acid. Calcium carbonate also reacts with water that is saturated with carbon dioxide to yield calcium bicarbonate, which can undergo further reactions with acidic compounds. In various embodiments the carbonate or bicarbonate salt is lithium, sodium, potassium, magnesium, or calcium, or a mixture of two or more thereof. The acid used to liberate carbon dioxide is selected by the user based on reactivity and edibility and/or palatability of the resulting salt that forms in the reaction with the carbonate species. In some embodiments, a blend of two or more acidic compounds is employed in the foaming feed compositions.

In some embodiments wherein the first reactive component is present in a foaming feed premix and the second reactive component is added to the composition to form the foaming feed composition, a carbonate or bicarbonate is the first reactive component and the acid or anhydride is the second reactive component. In other such embodiments, the acid or anhydride is the first reactive component and a carbonate or bicarbonate is the second reactive component. In some embodiments, a bicarbonate or carbonate are provided in one mixture with an anhydride, wherein the mixture is supplied in dry form in a package separate from a foaming feed premix that includes at least the water and one or more food components.

In some embodiments, the foaming feed compositions include citric acid as a palatant, as is discussed below in detail. In some such embodiments, at least a portion of the citric acid is provided as a dry powder to the foaming feed compositions; in some embodiments the citric acid is blended with water and the one or more food components. In some embodiments, the foaming feed premixes or compositions include a total of about 0.3 wt % to 1.5 wt % citric acid for use as a palatant. Citric acid is also usefully employed as a first reactive component, that is, it is added to a foaming feed premix, whereas sodium carbonate or sodium bicarbonate is advantageously employed as the second reactive component that is added to the foaming feed premix by the end user. In embodiments where citric acid is employed as a reactive component, the amount employed is adjusted to include the stoichiometric amount required to react with a carbonate or bicarbonate, or the stoichiometric amount plus an additional 0.3 wt % to 1.5 wt % based on the weight of the foaming feed composition or of the premix.

In one embodiment, citric acid and sodium bicarbonate are provided as the first and second reactive component, wherein both reactive components are blended in dry form; the mixture is a powder or a compressed tablet including at least the blend of reactive components. The foaming feed premix includes water, one or more food components, and optionally additional citric acid, a viscosifier, or both. The end user then adds the powder or the tablet to the premix in order to start the foaming reaction. Where the reactive components are added in tablet form, the rate of bubble formation in the foam feed composition is effectively slowed down due to the lowered surface area of contact between the premix and the reactive components as the tablet slowly reacts only at the surface of the tablet. Providing a combination of powder and a tablet allows a user to enable quick foam formation plus an extended period of foam formation.

In some embodiments, the first reactive component, second reactive component, or both are provided in a slow-release form, wherein the materials are encased within a coated pellet, granule, tablet, and the like. In some embodiments, the coating provided on the pellet, granule, tablet or the like is a water soluble or water swellable polymer, such that the polymer slowly dissolves upon addition of the coated pellet, granule, tablet or the like to a foaming feed premix and foaming action is initiated upon contact of the water with the first reactive component, second reactive component, or blend thereof. Such water soluble or swellable coatings are known in the industry and any such coatings are usefully employed herein. In some embodiments, a portion of the first reactive component, second reactive component, or both are provided in a slow-release form, and the remainder of one or more reactive components are provided without a protective coating in order to initiate some amount of immediate foaming upon contact with water or with the other reactive component.

The packaging employed in dispensing a two-part reactive component system is not particularly limited. In some embodiments, the user simply opens two packages and dispenses the contents thereof into a container such as a flask, bottle, or bucket and mixes the contents by hand before applying the foaming feed composition to the desired surface. In other embodiments, special packaging is employed to mix the two reactive components within a supplied package prior to dispensing, such as a single package with a perforatable membrane between the parts and a nozzle to dispense the mixed components onto the selected surface; or a bottle provided with a small package of powder the user is directed to add to the liquid contents of the bottle, wherein the bottle is shaken and then the contents applied to the selected surface. In some embodiments, the dispensing mechanism is a static mixer, such that mixing and dispensing of the two reactive component system is carried out contemporaneously. In some embodiments, the two part mixture is mixed and the left in the provided package, wherein the foaming reaction and concomitant volume increase of the foaming feed composition causes the foaming feed composition to move out of the package through an opening adapted for the dispensing.

In some embodiments of the foaming feed compositions, the foam is formed by dissolving carbon dioxide in the waterbased matrix of the foaming feed composition, then nucleating bubble formation of carbon dioxide by adding a nucleating agent. The use and effect of this approach is similar to the gas-forming chemical reaction approach, but differs in that no “reaction” takes place; rather, the dissolved gas is simply triggered to form bubbles by the presence of the nucleating agent. Famously, foaming of dissolved carbon dioxide by nucleation takes place in carbonated beverages, particularly those containing aspartame and potassium benzoate, when combined with the gelatin and gum arabic ingredients of a certain chewy mint candy; however, the rough surface of the candy has been shown to provide the major contribution to the explosive formation of carbon dioxide-based foam. Similarly, a two-part foam nucleation is useful in conjunction with the foam feed composition where, for example, the foaming agent is a gas that is dissolved in the water present in the foaming feed composition and maintained therein by employing an enclosed vessel—similar to carbonated beverages—but it is desirable to provide faster formation of the foam than is realized by the simple release of pressure from the container. In such embodiments, a nucleating agent such as a small food item with a high surface area (rough surface) is added by the user to a liquid foaming feed composition to nucleate the foam formation. In some such embodiments, a high surface area material, such as a powder, is added to by the user using a two-part packaging system similar to any of those described above. The powder is a food item in some such embodiments.

In some embodiments the foaming feed compositions further include one or more foam stabilizers. “Foam stabilization” means to slow the rate of eruption of the bubbles present in the foam, regardless of the mechanism of their formation. “Foam stabilizers” or “foam stabilizing agents” are thus any material or compound that serves to slow bubble eruption of the foam, prolonging foam lifetime. In some embodiments, the foam stabilizer is a nonionic surfactant. Suitable nonionic surfactants include, for example, ethoxylated fatty alcohols, fatty acid alkanolamides, fatty amine oxides, octyl- or nonylphenol ethyoxylates, and sorbitan esters and their ethoxylates such as polyoxyethylene (20) sorbitan monooleate; many others are known and used in the food industry for foam stabilization. In embodiments, the foam stabilizer is a food-safe surfactant or a GRAS surfactant. In some embodiments where the foaming feed composition is a thickened foaming feed composition, the viscosifiers employed to form the paste are also foam stabilizers; viscosifiers are described in detail below. In some embodiments, the foam stabilizer is a blend of two or more foam stabilizers, for example, a combination of a viscosifier and a nonionic surfactant, or two surfactants, or two viscosifiers.

It will be appreciated that in various applications, the foaming feed compositions advantageously employ foams wherein bubbles form and erupt quickly; form slowly, or form quickly but erupt slowly. Thus, one of skill will understand that the desired rate of both foam formation and subsequent bubble eruption are advantageously achieved by combining one or more of the foam formation components recited above, optionally with one or more foam stabilizing agents as further recited herein, wherein in some embodiments the foam stabilizing agents are nonionic surfactants or viscosifiers or a combination thereof. It will further be appreciated that in some embodiments, one or more food components also affect the rate of foam formation, the rate of bubble eruption, or both. Whether the food components accelerate or decelerate foam formation or bubble eruption depends on the nature of both the foam composition and the composition of the food component, and the manner in which they interact to increase or decrease surface tension of the gas/liquid interface that defines the foam. In some embodiments the food component even participates in a foam-forming chemical reaction or accelerates a foam-forming chemical reaction.

The foaming feed compositions include at least one food component. Food components are employed in the foaming feed compositions as single components or in a wide variety of combinations that are not particularly limited by their recitation herein; it will be appreciated by those having skill that food components are selected for palatability to the selected species and also for purpose. Examples of some purposes include attraction of deer for hunting, animal behavior modification or training, animal enrichment, basic nutrition, supplemental nutrition, easy to digest nutrition for sick animals, and the like.

In general, food components known to be palatable to the selected animal, wherein individual food items are smaller in size than about 2 cm in any one dimension are suitably employed in the foaming feed compositions. In embodiments, the food components are particulate, granular, or flake-like in nature, having particle sizes of 5 mm or less in the largest direction or less, or about 1 mm or less in the largest direction. In some such embodiments, for example, the food components have particle sizes of about 5 mm to 1 μm, or about 3 mm to 5 μm, or about 1 mm to 5 μm mm in the largest direction, wherein the target animal cannot pick the food item out of the composition and carry it away. In some embodiments, the food components are soluble or dispersible in the composition, wherein the individual portions thereof cannot be separated from the paste feed composition by the animal.

In embodiments, the one or more food components of the foaming feed compositions include at least one carbohydrate. In embodiments, the one or more food components include one or more carbohydrates and one or more proteins. In embodiments, the one or more food components include one or more carbohydrates and one or more fats. In embodiments, the one or more food components include one or more carbohydrates, one or more proteins, and one or more fats.

Carbohydrates are usefully provided in the foaming feed compositions at about 10 wt % to 90 wt % based on the total weight of the foaming feed compositions, or about 15 wt % to 90 wt %, or about 20 wt % to 90 wt %, or about 25 wt % to 85 wt %, or about 30 wt % to 80 wt %, or about 35 wt % to 80 wt %, or about 40 wt % to 80 wt %, or about 45 wt % to 75 wt %, or about 50 wt % to 75 wt %, or about 50 wt % to 70 wt % based on the total weight of the feed composition, or any compositional amount within the range of 10 wt % to 90 wt % in 1 wt % increments (such as 16 wt % to 23 wt %, 84 wt % to 85 wt %, and the like). Where one or more fats are included in the foaming feed compositions, the one or more fats are present at about 0.1 wt % to 10 wt % based on the total weight of the composition, or about 0.25 wt % to 9 wt %, or about 0.25 wt % to 8 wt %, or about 0.25 wt % to 7 wt %, or about 0.25 wt % to 6 wt %, or about 0.50 wt % to 6 wt %, or about 0.50 wt % to 5 wt %, or about 0.50 wt % to 4 wt %, or about 0.50 wt % to 3 wt %, or any compositional amount within the range of 0.1 wt % to 10 wt % in 0.1 wt % increments (such as 0.3 wt % to 9.7 wt %, 2.6 wt % to 2.7 wt %, and the like).

One suitable food component is a sugar-containing food component. Where employed in the foaming feed compositions, a sugar-containing component is a carbohydrate source. One or more sugar-containing food components are usefully employed in the foaming feed compositions. Sugar containing food components include, for example, molasses, honey, sugarcane, sugar beet, fruit, fruit portions, fruit extracts, and the like. In some embodiments, the sugar containing food source is dried prior to use; for example, molasses or honey may be further dried to remove water prior to use in the foaming feed compositions of the invention. Where employed, the total amount of sugar-containing food components generally ranges from about 10 wt % to 90 wt % of a foaming feed composition. In some embodiments the sugar-containing food component is present at about 10 wt % to 85 wt % based on the total weight of the composition, or about 15 wt % to 80 wt %, or about 20 wt % to 75 wt %, or about 20 wt % to 70 wt %, or about 20 wt % to 65 wt %, or about 25 wt % to 60 wt %, or about 25 wt % to 55 wt %, or about 25 wt % to 50 wt % based on the total weight of the composition or any compositional amount within the range of 10 wt % to 90 wt % in 1 wt % increments (such as 16 wt % to 23 wt %, 54 wt % to 75 wt %, and the like).

Another suitable food component is a C3-C7 sugar, a sugar alcohol, or a combination of two or more thereof. Where employed in the foaming feed compositions, C3-C7 sugars and sugar alcohols are carbohydrate sources. One or more sugars, sugar alcohols, and combinations thereof are usefully employed in the foaming feed compositions. Examples of suitable sugars include fructose, glucose, galactose, sucrose, maltose, and lactose, or two or more thereof. Examples of suitable sugar alcohols include adonitol, allitol, altritol, arabinitol, dulcitol, erythritol, galaxitol, glucitol, glycerol, iditol, inositol, isomalt, lactitol, maltitol, mannitol, perseitol, ribitol, rhamnitol, sorbitol, threitol, and xylitol or two or more thereof. Combinations of various sugar-containing food components, sugars, and sugar alcohols are suitably employed as food components in the foaming feed compositions.

Where employed in a foaming feed composition, a C3-C7 sugar, a sugar alcohol, or combination thereof is present at a total amount of about 1 wt % to 80 wt % based on the total weight of the composition, or about 5 wt % to 75 wt %, or about 10 wt % to 75 wt %, or about 20 wt % to 70 wt %, or about 20 wt % to 65 wt %, or about 25 wt % to 60 wt %, or about 25 wt % to 55 wt %, or about 25 wt % to 50 wt % based on the total weight of the composition or any compositional amount within the range of 1 wt % to 80 wt % in 1 wt % increments (such as 6 wt % to 23 wt %, 74 wt % to 75 wt %, and the like).

Another suitable food component is whole grain, ground grain, or a grain component. Where employed in the foaming feed compositions, a whole grain, ground grain, or a grain component is a source of carbohydrate, protein, fat, or all of these. Grain components include bran, germ, endosperm, or portions thereof. Suitable examples of grains include natural or genetically engineered grains including amaranth, barley, buckwheat, bulgur, corn, einkom, farro, grano, khorasan grain, kaniwa, millet, oats, quinoa, rice, rye, sorghum, spelt, triticale, wheat (including durum wheat, and bread wheat including hard wheat, soft wheat, white wheat, red wheat, winter wheat, and spring wheat), and wild rice. Where employed in foaming feed compositions, the total amount of whole grain, ground grain, or a grain components is present at a total amount of about 5 wt % to 50 wt % of the edible composition, or about 10 wt % to 50 wt %, or about 10 wt % to 40 wt %, or about 15 wt % to 30 wt %, or about 20 wt % to 30 wt % of the total weight of the foaming feed composition, or any compositional amount within the range of 5 wt % to 50 wt % in 1 wt % increments (such as 6 wt % to 8 wt %, 16 wt % to 52 wt %, and the like).

Another suitable food component is a plant-based oil. Where employed in the foaming feed compositions, a plant-based oil is a source of fat. Oils derived from plants, and combinations of two or more such oils, include expressed oils, distilled oils, and extracted oils. In embodiments, suitable plant oils are extracted from the fruits or seeds of plants, and the oils may be classified by grouping oils from similar plants, such as “nut oils”, “citrus oils”, or “legume oils.” Examples of plant oils that are usefully employed as food components in the foaming feed compositions include coconut oil, palm oil, corn oil, walnut oil, almond oil, acai oil, flaxseed oil, tung oil, avocado oil, apple seed oil, theobroma oil, grape seed oil, rice bran oil, shea butter, tea see oil, cottonseed oil, olive oil, peanut oil, rapeseed oil, sesame oil, soybean oil, sunflower oil, wheat germ oil, and mustard oil. Where employed in foaming feed compositions, the total amount of plant-based oil generally ranges from about 0.1 wt % to 10 wt % of the total weight of the composition, or about 0.25 wt % to 9 wt %, or about 0.25 wt % to 8 wt %, or about 0.25 wt % to 7 wt %, or about 0.25 wt % to 6 wt %, or about 0.50 wt % to 6 wt %, or about 0.50 wt % to 5 wt %, or about 0.50 wt % to 4 wt %, or about 0.50 wt % to 3 wt % based on the total weight of the foaming feed composition, or any compositional amount within the range of 0.1 wt % to 10 wt % in 0.1 wt % increments (such as 0.3 wt % to 9.7 wt %, 2.6 wt % to 2.7 wt %, and the like).

Another suitable food component is a whole or ground legume, or an extract, or component thereof, including the oil thereof, and combinations of two or more thereof. Where employed in the foaming feed compositions, a whole or ground legume, or an extract, or component thereof is a source of carbohydrate, protein, fat, or all of these. Examples of suitable legumes include peanuts, chickpeas, various common strains of beans and peas, fava beans, lentils, lima beans, lupins, mung beans, pigeon peas, runner beans, and soybeans. Where employed in foaming feed compositions, the total amount of whole or ground legume, or an extract, or component thereof generally ranges from about 1 wt % to 75 wt % based on the total weight of the composition, or about 5 wt % to 60 wt %, or about 10 wt % to 50 wt % based on the total weight of the foaming feed composition, or any compositional amount within the range of 1 wt % to 75 wt % in 1 wt % increments (such as 6 wt % to 23 wt %, 56 wt % to 68 wt %, and the like).

Another suitable food component is a whole or ground seed or an extract, or component thereof, including the oil thereof, and combinations of two or more thereof. Where employed in the foaming feed compositions, a whole or ground seed or an extract, or component thereof is a source of carbohydrate, protein, fat, or all of these. Examples of suitable seeds include flax seed, safflower seed, sunflower seed, rapeseed including canola, and the like. Where employed in foaming feed compositions, the total amount of whole or ground seed or an extract, or component thereof generally ranges from about 1 wt % to 50 wt % based on the total weight of the composition, or about 5 wt % to 40 wt %, or about 10 wt % to 50 wt % based on the total weight of the foaming feed composition, or any compositional amount within the range of 1 wt % to 50 wt % in 1 wt % increments (such as 6 wt % to 23 wt %, 54 wt % to 55 wt %, and the like).

Another suitable food component is a mineral. Minerals include such compounds as monocalcium phosphate, dicalcium phosphate, calcium carbonate, sodium carbonate, sodium bicarbonate, sodium chloride, potassium chloride, potassium carbonate, potassium iodate, magnesium oxide, ferric oxide, ferrous oxide, calcium oxide, calcium hydroxide, chromic oxide, copper oxide, copper sulfate, zinc oxide, calcium chloride, copper sulfate, trace amounts of selenium, chromium, cobalt, molybdenum, manganese, fluoride, iodine, and the like, and vitamin supplements such as vitamin A, K, D, D3, various B vitamins, or E supplements.

Aside from one or more food components, water, and foaming agent, a number of additives are optionally included in various embodiments of the foaming feed compositions of the invention. Preservatives, stabilizers, emulsifiers, palatants (palatability enhancers) attractants, and combinations of two or more thereof are suitably included in the foaming feed compositions. The additives may be food safe for the selected animal.

Examples of suitable preservatives include sorbic acid, potassium sorbate, fumaric acid, propionic acid, and benzoic acid. Common antimicrobial preservatives include sorbic acid and its salts, benzoic acid and its salts, calcium propionate, sodium nitrite, sulfites (sulfur dioxide, sodium bisulfite, potassium hydrogen sulfite, etc.) and disodium EDTA. Antioxidants include BHA, BHT, TBHQ and propyl gallate. Other preservatives include ethanol and methylchloroisothiazolinone. Naturally occurring substances such as rosemary extract, hops, salt, sugar, vinegar, alcohol, diatomaceous earth and castor oil are also useful as preservatives in some embodiments of the foaming feed compositions. Another group of preservatives targets enzymes in fruits and vegetables that act on these plants after they are cut. For instance, the naturally occurring citric and ascorbic acids in lemon or other citrus juice can inhibit the action of the enzyme phenolase which turns surfaces of cut apples and potatoes brown. Vitamin C and Vitamin E are also sometimes used as preservatives.

Examples of suitable emulsifiers include egg yolk lecithin, mustard seed mucilage, soy lecithin, sodium stearoyl lactylate, and monoglyceride ester of diacetyl tartaric acid.

Examples of suitable stabilizers include those that prevent undesirable interactions within the edible compositions. For example, calcium sequestrants such as tetrasodium pyrophosphate are usefully employed to prevent interaction of calcium ions with other components of the edible compositions, thereby maintaining stability of the compositions.

One suitable palatant is citric acid. In some embodiments, the foaming feed compositions include citric acid. Suitable citric acid sources include certain fruits, fruit portions, or fruit extracts. In some embodiments, the citric acid source is isolated natural or synthetic citric acid provided as a dry powder to the foaming feed compositions. In some embodiments, a combination of fruit, fruit portions, or fruit extracts with isolated citric acid is employed in the foaming feed compositions. In various embodiments, the foaming feed compositions include a total of about 0.3 wt % to 1.5 wt % citric acid. In some embodiments, the edible compositions include about 0.4 wt % to 1.0 wt %, or about 0.5 wt % citric acid, or any compositional amount within the range of 0.3 wt % to 1.5 wt % in 0.05 wt % increments (such as 0.45 wt % to 0.75 wt %, 0.90 wt % to 1.25 wt %, and the like).

The availability of isolated citric acid is an advantage of using citric acid as a palatant in the edible compositions. Citric acid is generally widely available, and is inexpensive relative to many known flavor additives useful in edible mixtures for animals, including ruminants such as deer.

Other palatants suitably employed in the foaming feed compositions include vegetable or animal extracts, such as beef extract or fish oil; vitamins, minerals, salts, trace nutrients, or other elements or nutrients beneficial to the selected animal; or other compounds or mixtures thereof known to increase palatability to the selected animal. Palatants include Maillard reaction products of various sugars and proteins, and the like. In some embodiments, one or more palatants or a component thereof can become airborne and thus serve as an airborne attractant to the selected animal. For example, it is known by those of skill that Maillard reactions give rise to a complex combination of compounds, some of which become airborne to provide attractive aromas and some of which are flavor compounds that are not volatile. Such aromas are usefully employed in some embodiments of the invention where the foaming action of the foaming feed compositions acts to increase the amount of the aroma released into the environment in a selected period of time, which in turn causes the aroma to provide a threshold aroma level over a larger area. The threshold aroma level is the minimum concentration of an aroma in the air that is noticeable by the selected animal.

Examples of suitable attractants include pheromones and pheromone-containing substances including urine, estrous, and the like. Pheremones are behavior modifying biochemicals that in mammals are typically sensed by olfactory receptors. Pheromone-containing substances are mixtures that include at least one pheromone, and can include other aroma compounds, that are sufficiently volatile such that the scent thereof or another chemical signaling receptor associated with olfactory or other sensory perception is known to attract the selected animal. Such attractants are usefully employed in some embodiments of the invention where the foaming action of the foaming feed compositions acts to increase the amount of the attractant released into the environment in a selected period of time, which in turn causes the attractant to provide a threshold attractant level over a larger area. The threshold attractant level is the minimum concentration of an attractant in the air that is noticeable by the selected animal.

In embodiments where the foaming feed compositions are thickened foaming feed compositions, the composition includes one or more viscosifiers. Useful viscosifiers for forming the thickened foaming feed compositions of the invention include any known food-safe viscosifiers. In some embodiments, two or more viscosifiers are employed in combination, particularly where a combination of properties is desirable. It will be appreciated that different viscosifiers will be required at different levels, depending on efficacy in the particular combination selected, and desired consistency. In some embodiments, the amount of viscosifier employed in the thickened foaming feed compositions is between about 0.001 weight percent (wt %) and 5 wt % of the composition, for example about 0.005 wt % to 3 wt %, or about 0.01 wt % to 2 wt %, or about 0.05 wt % to 1 wt %, or about 0.005 wt % to 1 wt %, or about 0.01 wt % to 0.5 wt %, or about 0.005 wt % to 0.5 wt %, or about 0.01 wt % to 0.1 wt % of the thickened foaming feed compositions.

The thickened foaming feed compositions of the invention, once “set up”, have viscosity of at least about 10,000 centipoise (cP), and as high as about 5,000,000 cP; in some embodiments, the thickened foaming feed compositions have viscosity of about 50,000 cP to 3,000,000 cP, or about 100,000 P to 2,000,000 cP, or about 200,000 cP to 1,000,000 cP, or about 500,000 cP to 3,000,000 cP or about 1,000,000 to 4,000,000 cP, or about 2,000,000 cP to 4,000,000 cP. In some embodiments, the viscosity of the thickened foaming feed compositions varies less than about 50% between 20° C. and 50° C., for example less than about 40% between 20° C. and 50° C., or less than about 30% between 20° C. and 50° C., or less than about 25% between 20° C. and 50° C., or less than about 20% between 20° C. and 50° C., or less than about 10% between 20° C. and 50° C.

In some embodiments, the thickened foaming feed compositions have a Newtonian viscosity profile. In other embodiments, the thickened foaming feed compositions are thixotropic or pseudoplastic. In some embodiments, the thickened foaming feed compositions include a viscosifier wherein the viscosifier exhibits hysteresis. The viscosity profile of a thickened foaming feed composition is primarily dictated by the type and amount of the viscosifier employed in the composition, but in some embodiments is strongly influenced by the food components of the composition, the pH of the composition, or both. In some embodiments the thickened foaming feed compositions include combinations of two or more viscosifiers. It will be understood that where “viscosifier” is employed in the singular, it also includes the plural where allowed by context.

In some embodiments, the viscosifier is dissolved in water and crosslinked to provide high viscosity, such as by dissolving sodium alginate in water then adding a source of calcium to induce ionic crosslinking. In other embodiments, heat is required to dissolve the viscosifier and give rise to high viscosity, such as by using gelatin. In some embodiments, the viscosifier is a blend of two or more of these materials or a blend of these with additional additives known to interact with the viscosifier(s) to increase viscosity further or affect other properties in a manner that is advantageous for the thickened foaming feed compositions.

Suitable viscosifiers include gums, starches, inorganic colloids such as certain clays, and plant-based thickeners commonly employed in food. Examples of suitable viscosifiers include xanthan gum, locust bean gum, guar gum, agar, carrageenan, alginic acid, sodium alginate, gum arabic, gum ghatti, gum tragacanth, karaya gum, guar gum, chicle gum, dammar gum, glucomannan, psyllium seek husks, mastic gum, spruce gum, tara gum, gellan gum, arrowroot, corn starch, β-glucan, various types of cellulose or methyl cellulose, pectin, potato starch, gelatin, chondrin, press cake from Irvingia gabonensis, gum karaya, gulaman, montmorillonite clays, bentonite clays, attapulgite clays, and the like. In some embodiments, the viscosifier is a blend of two or more of these or a blend of these with additional additives known to interact with the viscosifier(s) to increase viscosity further or affect other properties in a manner that is advantageous for the thickened foaming feed compositions.

In some embodiments, the amount of viscosifier employed is between about 0.001 weight percent (wt %) to 5 wt % of the composition, for example about 0.005 wt % to 3 wt %, or about 0.01 wt % to 2 wt %, or about 0.05 wt % to 1 wt %, or about 0.005 wt % to 1 wt %, or about 0.01 wt % to 0.5 wt %, or about 0.005 wt % to 0.5 wt %, or about 0.01 wt % to 0.1 wt %.

In some embodiments, the selected viscosifier exhibits hysteresis. One example of a viscosifier that exhibits hysteresis is agar. Agar is a phycocolloid extracted from a group of red-purple marine algae (class Rhodophyceae) including Gelidium, Pterocladia and Gracilaria. Impurities, debris, minerals and pigment are reduced to specified levels during manufacture. Agarose, the gelling fraction of agar, is a neutral linear molecule consisting of chains of repeating alternate units of β-1,3-linked D-galactose and α,-1,4-linked 3,6-anhydro-L-galactose. Agar is available in powder, flake, thread, and bar form. Dissolved at 1%-2% w/v in boiling water, agar forms a transparent, firm, shear resistant gelatinous medium upon subsequently reaching 32° C.-40° C. However, once solidified, the agar does not “melt” or become re-liquefied at 32° C.-40° C. Rather, the gelled agar must be reheated to about 85° C. (185° F.) in order to liquefy. Some softening may occur starting at about 65° C. (149° F.). The phenomenon wherein a gelled mass melts, or liquefies, at a different temperature from that at which it solidifies is known as hysteresis.

The solidification and subsequent hysteresis behavior of agar, as an illustrative example, is useful in embodiments of the thickened foaming feed compositions. First, as will be discussed below, it is useful to form a slurry including at least water, one or more food components, and viscosifier at e.g. ambient temperatures wherein the viscosity does not immediately begin to build on account of the viscosifier addition. This allows for ease of mixing and packaging, in some cases including masterbatch formation and transportation or storage, followed by heating at a selected time to trigger increased viscosity. Second, the “set up” temperature of 32° C.-40° C., where the agar becomes gelled after heating, is advantageous, wherein the heated slurry can be packaged while at an elevated temperature and prior to “set up” to form the thickened foaming feed composition, wherein the thickened foaming feed composition is at the final selected viscosity. Third, the hysteresis of agar is of useful in some embodiments for outdoor use, particularly in warm weather. The hysteresis property of agar prevents the thickened foaming feed compositions from sagging, dripping, running, or flowing off of the selected location where the thickened foaming feed composition is placed, for example at temperatures near 40° C., in direct sunlight, or both.

In some embodiments, a viscosifier included iii the thickened foaming feed compositions of the invention exhibits pseudoplastic behavior. One example of a viscosifier that exhibits pseudoplastic behavior is xanthan gum. Xanthan gum is a bacterially synthesized polymer composed of glucose, mannose, and glucuronic acid repeat units in a characteristic 2:2:1 molar ratio. It is produced by the fermentation of glucose, sucrose, or lactose by Xanthomonas campestris. After a fermentation period, the polysaccharide is precipitated from a growth medium with isopropyl alcohol, dried, and ground into a fine powder. The powder is simply added to an aqueous medium to form the gum, wherein swelling occurs slowly over a period of time at ambient temperature. Xanthan gum produces a large increase in the viscosity at very small quantities, on the order of 0.5% or less by weight in water. Xanthan gum also has a characteristic tendency to prevent formation of ice crystals in frozen food compositions, providing a pleasant creamy texture to cold foods, and thus is useful in some embodiments of the thickened foaming feed compositions of the invention wherein cold environments, e.g. below 0° C. are expected. The viscosity of xanthan gum solutions decreases with higher shear rates; this is called shear thinning or pseudoplasticity. This means that thickened foaming feed compositions subjected to shear, whether from mixing, shaking or even chewing, will thin out, but once the shear forces are removed, the substance will immediately thicken back up. Unlike many other gums, xanthan gum is stable within a wide range of both temperature and pH, notably stable down to pH of 2, and it requires no heat in order to build viscosity. Xanthan gum is easily dispersed in an oil or glycol component, prior to addition of water, and thus may be premixed with one or more food components of the thickened foaming feed compositions for ease of mixing and to avoid formation of clumps when water is added.

In some embodiments, one or more of locust bean gum or guar gum are usefully employed as a viscosifier in the thickened foaming feed compositions. Locust bean gum and guar gum are seed gums produced by removing the outer coating of a seed, and grinding its endosperm. Both locust bean gum and guar are non-ionic galactomannans, that is, polysaccharides including galactose and mannose units. Guar gum has a mannose:galactose ratio of about 2:1 while locust bean gum has a mannose:galactose ratio of about 4:1. Locust bean gum in particular is useful for low temperature applications, for example where the thickened foam feed compositions are employed during winter months in cold climates. Locust bean gum is used in the thickened foam feed compositions at about 0.01 wt % to about 1.0 wt %. In some embodiments, the foam feed composition is slurried with the locust bean gum, then the slurry is heated to at least about 47° C. to dissolve the gum, giving rise to thickening.

In some embodiments, one or more carrageenans are usefully employed as viscosifiers in the thickened foaming feed compositions. Carrageenans are a family of linear, high-molecular-weight sulfated (anionic) polysaccharides that are extracted from red edible seaweeds. The carrageenan polysaccharide chains are made up of galactose and 3,6 anhydrogalactose (3,6-AG) units, sulfated and nonsulfated. Carrageenans bind strongly to proteins. There are three main varieties of carrageenan, which differ in their degree of sulfation. Kappa-carrageenan has one sulfate per disaccharide and forms hard, rigid gels in the presence of potassium ions. Iota-carrageenan has two sulfates per disaccharide and forms soft gels in the presence of potassium ions. Lambda-carrageenan has three sulfates per disaccharide and increases viscosity but does not gel. In embodiments, carrageenans are used in the thickened foam feed compositions at about 0.01 wt % to about 2.0 wt %. The carrageenans have nearly Newtonian rheological properties at the lower concentrations, with shear thinning properties (pseudoplasticity) developing at higher concentrations. In some embodiments, the foam feed composition is slurried with the carrageenan, then the slurry is heated to at least about 40° C. to dissolve the gum, for example where potassium or calcium salts of the sulfate groups are employed. In other embodiments, no heat is employed to form the thickened foaming feed compositions.

In some embodiments, a combination of viscosifiers is employed in the thickened foaming feed compositions. In particular, it is desirable to use two or more viscosifiers to impart desirable properties to the thickened foaming feed compositions, such as heat-induced set up and pseudoplasticity; or hysteresis and pseudoplasticity, or partial set up without heat, followed by complete set up with addition of heat, or some other combined set of properties desirably imparted by a blend of viscosifiers. In other embodiments, chemical interactions between viscosifiers lead to higher viscosity, or enhanced elasticity over the same weight of either viscosifier alone. Examples of such blends are xanthan gum with locust bean gum, locust bean gum with agar, carrageenan with locust bean gum, and xanthan gum with guar gum.

Method of Making

The foaming feed compositions are easy to make employing known industrial techniques and equipment. Both batch and continuous modes of manufacturing are advantageously employed by those of skill to make both the compositions and the foaming feed premixes. In some embodiments, a slurry is formed prior to forming a thickened foaming feed composition. A slurry is formed when at least one of the food components and a viscosifier are combined with water but the viscosity is not yet elevated to its final selected end point. In some embodiments, the dry ingredients, which include in some embodiments one or more food component(s), one or more viscosifiers, and one or more adjuvants, are blended together, followed by addition of water to the dry ingredients to form a slurry. In other embodiments, one or more dry ingredients are added directly to water. In some embodiments, slurry formation is followed by addition of heat to complete mixing or to set up the paste where one or more viscosifiers are included in the edible compositions. Heating the slurry includes adding heat sufficient to raise the temperature to about 30° C. to 100° C., or even above 100° C. if the vessel containing the slurry is enclosed such that pressure is suitably applied or if there are dissolved salts or other agents tending to raise the boiling point of water. In some such embodiments, the thickened foaming feed composition is packaged either before heating, or while the heated composition is still at a temperature above the temperature where set up is observed.

Where a propellant is employed in making the foaming feed composition, blending of ingredients is accomplished using means employed by those of skill in the art of mixing liquid animal feeds; then the composition is divided into dispensing containers and propellant is added under pressure.

In one example embodiment, a method of making a foaming feed composition includes mixing a one or more food components with water in a vessel to form a foaming feed premix; adding citric acid into the premix; and separately packaging sodium bicarbonate in a pouch, bag, envelope, tube, bottle, or other dispenser suitable for use with a dry powder.

In some embodiments the foaming feed compositions or foaming feed premixes are formed as masterbatches, and the masterbatches are subsequently packaged for individual use. A masterbatch is a batch composition having a volume of greater than about 20 liters, wherein the volume is not particularly limited as to upper range of size and could include e.g. a tanker or truckload. The masterbatch is packaged for shipment and/or storage. In some embodiments where heat is employed to cause set up of a thickened foaming feed composition or premix, a slurry is formed in masterbatches, wherein the blending of the masterbatch does not employ the addition of heat. At a selected time, the masterbatch is heated as a single batch, as part of a continuous process, or by breaking the masterbatch into several small batches. The heat added to the masterbatch is sufficient to cause the composition or premix to set up upon heating or upon subsequent cooling. Before heating, or after heating but prior to setup, or after blending the components at ambient temperature (about 15° C. to 30° C.) the masterbatch is divided into smaller batches or individual containers.

The individual containers having a foaming paste composition or premix contained therein are intended for an end user to carry to a selected location and apply in a manner selected by the user and appropriate to the viscosity, amount of foam, and rate of foam formation in the particular foaming feed composition. The individual containers hold about 1 mL to 10 liters, or about 100 mL to 5 liters, or about 1 liter to 10 liters of the edible composition. In some embodiments, the individual containers are cups or buckets, with lids that are removable and reusable. In some embodiments, the individual containers are elongated cylindrical tubes having a nozzle on one end and a movable plunger on the other end, wherein the tube is adapted for use with a caulk gun type apparatus. In some embodiments, the individual container is a toothpaste tube having a collapsible body and a removable and reusable cap that is snapped on or screwed on. In some embodiments, the individual container is a sealed sleeve formed from a thermoplastic film, such as polyethylene, polypropylene, or polyester film, and the film is adapted to be cut open on one end and the feed composition urged out of the tube by the end user collapsing or rolling the tube on the end opposite from the cut end.

In some embodiments, the foaming feed composition components are formulated in a single batch or in a continuous process and are loaded directly into individual containers. In some embodiments, rather than employ a masterbatch, the individual containers are filled with the feed composition directly, for example at the end of a continuous mixing process employing e.g. an extruder type apparatus. In some embodiments where heat is required to set up a thickened foaming feed composition, the containers are filled prior to heating, and the heating is carried out in the individual container.

Method of Using

It is a feature of the present invention that the foaming feed compositions are easy to use by an end user; in some embodiments, the foaming feed compositions are used in the same way as conventional deer feed compositions.

Where the end user employs a cup or bucket of the foaming feed composition, in some embodiments the foaming feed composition is simply set out as is, and bubbles allowed to form and erupt within the bucket or cup. In other embodiments, a paint mixing stick, spatula, knife, scoop, spoon, brush, or roller, or two or more of these are useful to meter out portions of the foaming feed composition onto a selected surface. The foaming feed composition is applied to the selected surface in any desired amount. Where a thickened foaming feed composition is employed, layer thickness of greater than 1 mm (prior to foaming) and up to any desired thickness, for example about 2 mm to 10 cm, or about 2 mm to 5 cm, or about 2 mm to 1 cm are applied with ease to any selected surface.

The viscosity of the thickened foaming feed compositions are sufficient to prevent gravity-assisted flow at temperatures as high as 50° C. to 85° C., or 60° C. to 80° C., or 65° C. to 75° C., or 50° C. to 70° C., yet the thickened foaming feed composition is easily applied to a variety of surfaces by use of shear or extension force applied by a user. As discussed above, in some embodiments the thickened foaming feed composition includes a viscosifier that is pseudoplastic; in some such embodiments, shear applied by the end user during application is sufficient to cause significant thinning of the composition, making it easy to work and apply. The pseudoplastic property also causes the composition to “set up” again immediately upon cessation of the shear force. The thickened foaming feed composition will not melt even when placed in direct sunlight at temperatures as high as 50° C. or more, in some embodiments as high as 85° C. This advantage provides for foam stabilization during warm days and in direct sunlight.

In embodiments where the foaming feed composition is a thickened foaming feed composition, the selected surface may be horizontal, vertical, or anywhere in between. If desired, the thickened foaming feed composition can be worked into the crevice of a knothole of a tree, into the gaps and crevices between rough or peeling bark and a tree trunk, into crevices between rocks or into pits, cracks, fissures, or other natural features in rocks, into the crotch of a tree branch point, or into some portion of a man-made apparatus. Even where the foaming feed composition does not employ a viscosifier, the foaming action of the foaming feed composition is usefully employed in a method wherein the foaming feed composition is added to the interior of a vessel, tree trunk, or the like wherein the target animal cannot reach it; but as the foaming action causes the volume of the foaming feed composition to increase, the foam is dispensed into an area where the selected animal can reach it.

In one method, a foaming feed composition is used to establish a pattern of behavior in a wild or semi-wild animal wherein the animal is conditioned to return to a selected spot on a repeated basis. A wild animal is an animal that is not conditioned to accept or expect human interaction. A semi-wild animal is an animal that has been conditioned to accept or expect limited human interaction, for example bottle-feeding, hand feeding, and the like. The foaming feed compositions of the invention are useful to establish such behavior patterns in wild or semi-wild animals in open, semi-enclosed, or large enclosed areas. A semi-enclosed area is an area that includes one or more fenced regions wherein the fenced regions are not fully enclosed. Typically, but not always, the fenced areas in a semi-enclosed area describe land areas larger than 1 acre, and up to 10 acres, or up to 100 acres, or up to 1000 acres, or even larger. Enclosed areas are small in some embodiments, for example between about 1 acre and 10 acres, and are large in other embodiments, for example about 100 acres up to 1,000 acres, or 10,000 acres, or 100,000 acres or more.

In some embodiments, the selected area is an enclosed area that is stocked with deer, for example for hunting purposes. In one representative example, an enclosed area including about 1000 acres of land may have 1000 or more semi-tamed deer stocked within the area. In other embodiments the selected area is an open area where deer are scarce. In one representative example, in open area of about 1000 acres includes between 10 and 100 wild deer. In yet some other embodiments, the selected area is a semi-enclosed area that is set up to concentrate a wild population of deer and limit their movement once within the boundaries of the partial enclosure. An unlimited number of combinations of land and enclosure sizes and types exist, as well as degree of proliferation of deer or another selected wild or semi-tame animal, as will be appreciated by one of skill. All such combinations are addressed using the foaming feed compositions of the invention to a greater extent than with previous food attractants, due to the attractive scent or other olfactory sensed compound that is dispersed effectively by the erupting bubbles in the foam.

Further, the thickened foaming feed compositions of the invention provide for increased foam stability, allowing for controlled release of the compounds entrained in the foam bubbles by slowing the rate of eruption. Additionally, due to high viscosity some portion of the thickened foaming feed compositions remain in place when applied within cracks, crevices, convolutions, folds, pits, and the like within a selected surface, thereby providing the possibility of longer-term attraction of the selected animal to the selected location. Whereas conventional food attractants would be quickly eaten by the animal due to the easy availability thereof, some portion of the thickened foaming feed compositions of the invention can be made to remain at the selected location for days or even weeks after application to the selected surface, because the animal cannot reach it and the foaming feed composition does not flow out once the foam is depleted. In some embodiments, even where the majority of the composition has been consumed, there is a sufficient amount of the composition residing within one or more cracks, crevices, and the like to attract the animal, for example via the odor thereof. The foaming action also provides an additional means to force the edible foam paste composition into the cracks, crevices, etc. where the deer cannot reach it, thereby increasing longevity of the composition even further.

The cumulative effect of these advantages is an increased ability to attract a selected animal to a selected location. This in turn allows the user to obtain animal behavior modification such as repeat visits by one animal or a group of animals with superior results. Establishing a pattern of behavior of a wild or semi-tame animal in an open, semi-enclosed, or large enclosed area is thereby accomplished with ease.

In embodiments, the durable viscosity of the thickened foaming feed compositions act to attract or enrich the selected animal for about 1 to 30 days after application to the selected location, for example about 2 to 25 days after application to a selected surface, or about 2 to 20 days after application, or about 2 to 15 days after application, or about 2 to 12 days after application, or about 2 to 10 days after application, or about 2 to 25 days after application, or about 4 to 25 days after application, or about 7 to 25 days after application, or about 10 to 25 days after application, or about 15 to 25 days after application, or about 15 to 21 days after application.

In some embodiments, the foaming feed compositions of the invention are used to establish a pattern of returning behavior in a wild or semi-wild ruminant mammal of the family Cervidae, wherein 1 to 1000 animals, or 10 to 500 animals, or 10 to 100 animals, or 1 to 25 animals, or 1 to 10 animals are conditioned to return to the selected location having the foaming feed composition applied thereto on a repeated basis after 1 application of the foaming feed composition, or after 1 to 2 applications, or after 1 to 5 applications, or after 2 to 5 applications of the foaming feed composition to the selected location. In some embodiments the “selected location” is a single point location, that is, a single selected surface; in other embodiments, it is between 2 and 10 selected surfaces within a 1 mile radius, or 2 to 100 selected surfaces within a 1 mile radius. In some such embodiments, the selected location is an open, semi-enclosed, or large enclosed area.

In some embodiments, the foaming feed compositions of the invention are used to establish a pattern of returning behavior in a wild or semi-wild ruminant mammal of the family Cervidae for a selected period of time. In some embodiments, the selected period of time is 12 hours, or 24 hours, or 48 hours, or 72 hours, or greater than 72 hours. In some embodiments, the selected period of time is at least about a week, between one week and two weeks, at least about two weeks, or longer. In some embodiments, the selected period of time ends at the start of a hunting season for Cervidae.

### EXAMPLES

The following examples are illustrative of the foaming feed compositions of the invention. Additional examples and variations will be apparent to those of skill.

### Example 1

A foaming feed premix was formed by adding cane molasses (53.77 wt %), water (22.00 wt %), tetrasodium pyrophosphate (0.03 wt %) and attapulgite clay (0.60 wt %) to a 1 qt OSTERIZER® 10 speed blender (obtained from Sunbeam Products Inc. of Boca Raton, Fla.) and blending for 2 minutes; followed by addition of gum Arabic (1.20 wt %; obtained from TIC Gums, Inc. of White Marsh, Md.) and soy oil (0.4 wt %) were added to the blender and the resulting mixture blended for an additional 30 seconds. Then NaCl (3.50 wt %), propionic acid (0.50 wt %), citric acid (0.50 wt %) and rice bran (17.50 wt %, obtained from NutraCea Inc. of Scottsdale, Ariz.) were added to the blender and the resulting mixture blended for an additional 2 minutes.

The premix was poured into a 16 oz. plastic cup and crushed ALKA-SELTZER® tablets (obtained from Bayer Healthcare LLC of Whippany, N.J.) were added to the premix at 10 wt % based on the weight of the premix; the tablets were mixed into the premix by hand. The liquid expanded to about 5 times its original volume over about 2 minutes. The foam collapsed and again expanded to about 3 times its volume. This foam collapsed after about 5 minutes. After expanding and collapsing multiples times the appearance was similar to the starting premix liquid.

### Example 2

The procedure of Example 1 was repeated, except using Acacia propylene glycol alginate (obtained from TIC Gums, Inc. of White Marsh, Md.) instead of gum Arabic. In one portion of premix, the alginate was added at 0.60 wt %; in a second portion, the alginate was added at 1.20 wt %. In the portion having 0.60 wt % alginate, the bubbles formed quickly but erupted as soon as they formed; thus, a foam did not result. The portion having 1.20 wt % alginate formed a dark brown foam that appeared similar to the foam obtained using the gum Arabic.

### Example 3

The premix forming procedure of Example 1 was repeated except that the premix was formed in a 5 gallon Myers mixer (obtained from Myers Engineering, Inc. of Bell, Calif.). The viscosity of the premix was measured at ambient temperature (20°-21° C.) and was determined to be 4000 cP using a Brookfield viscometer, #6 spindle, 100 rpm.

Instead of ALKA SELTZER® tablets, citric acid and sodium bicarbonate were admixed by hand and the powders added at 10 wt % to portions of the premix that were dispensed into plastic buckets. A first power was admixed having 67:33 weight ratio of sodium bicarbonate to citric acid. A second powder was admixed having a 45:55 weight ratio of sodium bicarbonate to citric acid. The powders were added to the premix portions in the buckets, and blended by hand.

After addition of the powders, rapid expansion of both mixtures was observed, wherein the volume increased about 5 times the starting volume before the foam collapsed to its original volume. It then expanded to about 4 times it original volume and eventually collapsed again. Then the volume expanded to double the original volume.

### Examples 4-7

ANTLERMAX® Deer Mineral was obtained from Purina Animal Nutrition, LLC of Shoreview, Minn. and was used to form a foaming feed composition. ANTLERMAX® was dry blended with the ingredients listed in Table 1 using a 5 quart planetary kitchen mixer.

TABLE 1
Dry ingredients blended in the indicated ratios.

| | Example No. | | | |
|---|---|---|---|---|
| | 4 | 5 | 6 | 7 |
| ANTLERMAX ®, wt % | 90.00 | 89.50 | 90.00 | 90.00 |
| Gum arabic, wt % | 0 | 0.5 | 0 | 0 |
| Citric acid, wt % | 5.50 | 5.50 | 5.50 | 5.50 |
| Sodium bicarbonate, wt % | 4.50 | 4.50 | 0.00 | 2.25 |
| Calcium carbonate, wt % | 0 | 0 | 4.50 | 2.25 |
| TOTAL | 100.0 | 100.0 | 100.0 | 100.0 |

Water was added to the dry blended ingredients, wherein 1:1 wt:wt ratios of water to dry ingredients were used in each Example. In each Example, foaming was observed for about 3 minutes after addition of water. No difference was observed between Examples 4 and 5. Examples 7 foamed less than Examples 4 and 5, and Example 6 foamed less than Example 7.

### Example 8

About 18 kg DONKEY JUICE® (obtained from Primos Hunting of Flora, Miss.) and 1150 g citric acid were added to a 5 gallon Myers mixer (obtained from Myers Engineering, Inc. of Bell, Calif.) and blended. The mixture was dispensed into 5 gallon buckets. Then 900 g batches of sodium bicarbonate powder were packaged separately in plastic bags to provide for addition to the bucket contents. About ½ of the contents of one bucket was poured into a hole in the ground and one 900 g bag of sodium bicarbonate was added to a liquid and the contents stirred, the mixture foamed up out of the hole and spread over the ground.

Although the present disclosure provides references to preferred embodiments, persons skilled in the art will recognize that changes may be made in form and detail without departing from the spirit and scope of the invention. The invention illustratively disclosed herein can be suitably practiced in the absence of any element which is not specifically disclosed herein. While the invention is susceptible to various modifications and alternative forms, specifics thereof have been shown by way of examples, and are described in detail. It should be understood, however, that the invention is not limited to the particular embodiments described. On the contrary, the intention is to cover modifications, equivalents, and alternatives falling within the spirit and scope of the invention.

Additionally each and every embodiment of the invention, as described here, is intended to be used either alone or in combination with any other embodiment described herein. In various embodiments, the invention suitably comprises, consists essentially of, or consists of the elements described herein and claimed according to the claims appended below. It will be understood that “consisting essentially of” recited in a preamble to a claim means that the claim is limited to the specified materials or steps and those that do not materially affect the basic and novel characteristic(s) of the claimed invention.

1. A method of attracting wild or semi-wild ruminant mammal of the family Cervidae, the method comprising:
obtaining a foaming feed premix comprising, one or more food components, and a first reactive component;
obtaining a second reactive component;
placing one of the foaming feed premix or the second reactive component on a surface proximate an area where the Cervidae are to be attracted; and
combining the second reactive component with the foaming feed premix to form a foaming feed composition;
wherein the foaming feed composition produces bubbles adapted to attract the Cervidae to the area.

2. The method of claim 1 wherein the first reactive component comprises citric acid and the second reactive component comprises sodium bicarbonate.

3. The method of claim 2 wherein citric acid is present in an amount greater than the stoichiometric amount required to react with all the sodium bicarbonate provided.

4. The method of claim 1 wherein the foaming feed composition is placed at the one or more selected locations a number of times sufficient to establish the pattern of returning behavior.

5. The method of claim 4 wherein the foaming feed composition is placed at the one or more locations over a selected period of time, the selected period of time extending for at least one week.

6. The method of claim 5 wherein the selected period of time ends before the start of a hunting season or at the start of the hunting season for the Cervidae.

7. The method of claim 4 wherein the one or more selected locations are open, semi-enclosed, or large enclosed areas.

8. The method of claim 1 wherein the one or more food components comprises a mineral, a carbohydrate, a grain component, or a combination thereof.

9. The method of claim 1, wherein the first reactive component of the foaming feed premix comprises an organic acid or anhydride thereof and a carbonate or a bicarbonate.

10. The method of claim 9, wherein the second reactive component comprises water.

11. The method of claim 10, wherein the foaming feed premix is dry at least prior to the step of placing.

12-18. (canceled)

19. A method of attracting an animal, the method comprising:
obtaining a foaming feed premix comprising, one or more food components, a first reactive component and a second reactive component;
placing the foaming feed premix on a surface proximate an area where the animal is to be attracted; and
activating the foaming feed premix to form a foaming feed composition;
wherein the foaming feed composition produces bubbles adapted to attract the animal to the area.

20. The method of claim 19 wherein the animal is an elk, a wild boar, a feral pig, a game bird, a bear, a goat, a sheep, a moose, or a wolf.

21. The method of claim 19, wherein the foaming feed premix is dry and the step of activating the foaming feed premix involves dissolving at least one reactive component to initiate an acid-base reaction with the other of the reactive components.

22. The method of claim 21, wherein the at least one reactive component is dissolved by water.

23. The method of claim 21, wherein the at least one reactive component dissolved comprises an organic acid.

24. The method of claim 23, wherein the organic acid comprises citric acid.

25. The method of claim 24, wherein the other of the reactive components comprises a carbonate or a bicarbonate.

26. The method of claim 19, wherein the step of activating the foaming feed composition is performed a number of times sufficient to establish the pattern of returning behavior.

27. The method of claim 19, wherein the one or more food components is a primary component of the foaming feed composition and is present at a higher percentage, by weight, relative to other components of the foaming feed composition.
